(19) United States
(12) Patent Application Publication
(10) Pub. No.: US 2002/0152240 A1
(43) Pub. Date: Oct. 17, 2002

(54) Insertion of space in a geometric document

(75) Inventors: Leonid M. Kitainik, Cupertino, CA (US); Alexander Pashintsev, Cupertino, CA (US); Ilia Lossev, Mountain View, CA (US)

Correspondence Address: MERCHANT & GOULD PC, P.O. BOX 2903, MINNEAPOLIS, MN, 55402-0903, US

(73) Assignee: Parascript LLC

(21) Appl. No.: 10/123,732

(22) Filed: Apr. 15, 2002

Related U.S. Application Data
(60) Provisional application No. 60/284,075, filed on Apr. 16, 2001.

(51) Int. Cl. G06F 17/00

(52) U.S. Cl. 707/517

(57) ABSTRACT

In an electronic-mail computing system having a display and a pointing device for entering geometric elements in a geometric document, additional writing space is inserted in an existing geometric document having original space with one or more original geometric elements. This is accomplished by creating a boundary line or split line and inserting open or free space at the boundary line in the document. Further, an insertion of a boundary line in the midst of a geometric elements of a document to split the elements and add free space is accomplished by grouping geometric elements split by the boundary line or split line and then locating grouped geometric elements on one side or the other of the split line before space is inserted at the split line. The split line on the geometric document is detected, and original geometric elements crossed by the split line are detected and identified as crossed geometric elements. Any original geometric elements connected to or related to the crossed geometric elements are grouped to collect them into one or more geometric element groups. Each of the geometric element groups is analyzed to determine which side of the split line each group should be located. Then a duplicate split line is dragged using the pointing device from an original split line position to a new position while leaving the original split line at the original split line position. Open space is inserted between the split line and the duplicate split line.

### RELATED APPLICATIONS

This application claims the benefit of priority of U.S. provisional application Serial No. 60/284,075, filed Apr. 16, 2001.

### FIELD OF THE INVENTION

This invention relates to inserting space for additional text or drawings in a geometric document in a computing system by use of a pointing device such as a pen, stylus or mouse working with a computing system display. More particularly this invention relates to opening up space in a geometric document for editing or replying to a message in the geometric document.

### BACKGROUND OF THE INVENTION

Handwritten electronic mail (e-mail) is becoming a preferred mode of communication with the advent of wireless hand-held computing devices such as palm size computers, pagers or intelligent telephones or computing tablets. These computing systems may have a pen, a stylus or a cursor control device with which to free hand write messages and draw shapes on the display screen for the purpose of entering information into the computing system. One of the necessary operations in working with geometric documents will be the ability to reply to or to edit such documents.

A geometric document is a page defined by its geometrical space rather than the quantity of text lines or number of drawing fields in the document. The document contains geometric elements including text, shapes, lines and pictures. The text is typically handwritten but might also by computer print text. Shapes would typically be free hand drawn shapes entered by stylus or cursor, but might also be computer drawn shapes selected from a standard or reference set of shapes. Lines may be hand drawn or computer drawn; they are usually associated with shapes and might be connecting lines between shapes, dimension lines for shapes or annotation lines connecting text and shapes. Lines might also be independent of shapes as in demarcation lines to separate portions of the document. Finally, pictures are often added to documents now. These pictures might be hand drawn, or they might be preexisting pictures that have been pasted into the geometric document.

Replying to or editing an original geometric document often requires space to be added to the geometric document at the beginning or end of the document or in the middle of the document. Providing additional free space in the middle of the document requires splitting or separating geometric elements in the document and inserting the space between the original geometric elements in the document.

A problem that arises in inserting space in a document is a determination as to where to place the original geometric elements—text, shapes, lines and pictures—that are near the insertion location. In other words, on which side of the insertion space should the elements be placed or should some elements be placed on one side and other elements on the other side. A further problem is how to preserve the continuity of elements already in the document when inserting the open or free space for adding more content to the document.

### SUMMARY OF THE INVENTION

In accordance with this invention the above problem and other problems have been solved by creating a boundary line or split line and inserting open or free space at the boundary line in the document. Further, an insertion of a boundary line in the midst of a geometric elements of a document to split the elements and add free space is accomplished by grouping geometric elements split by the boundary line and then locating grouped geometric elements on one side or the other of the boundary line before space is inserted at the boundary line.

In an electronic-mail computing system having a display and a pointing device for entering geometric elements in a geometric document, additional writing space is inserted in an existing geometric document having original space with one or more original geometric elements. This is accomplished by detecting a split line entered on the geometric document and detecting original geometric elements crossed by the split line and identifying them as crossed geometric elements. Any original geometric elements connected to or related to the crossed geometric elements are grouped to collect them into one or more geometric element groups. Each of the geometric element groups is analyzed to determine which side of the split line each group should be located at. Then a duplicate split line is dragged using the pointing device or otherwise moved from an original split line position to a new position while leaving the original split line at the original split line position. Open space is inserted between the split line and the duplicate split line.

The grouping of the geometric elements is accomplished by marking the geometric elements connected or related to the crossed geometric elements to create marked geometric elements. The marked geometric elements are then grouped into one or more groups of geometric elements. Further, the complexity of the marked geometric elements as a potential group is tested to indicate whether or not the group is too complex for an automatic splitting decision. If the potential group is not too complex, the marked geometric elements are grouped. If the group is too complex, a dialog is displayed to the user to invite the user to accept or reject a group.

The location analysis for each group is accomplished by detecting spatial characteristics of each group of geometric elements; and evaluating the spatial characteristics against predetermined criteria to determine a group location for each group of elements on one side or other side of the split line. Further, the group location can be tested to determine if it has a predetermined certainty. If group location does not meet the predetermined certainty test, the location analysis based on the spatial characteristics for each group is expanded. If the expanded analysis does not provide a clear answer for a group location, a dialog with the user gives the user an opportunity to select the group location.

The invention may be implemented as a computer process, a computing system or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

These and various other features as well as advantages, which characterize the present invention, will be apparent from a reading of the following detailed description and a review of the associated drawings.

### BRIEF DESCRIPTION OF THE DRAWINGS

FIG. 1 is an illustration of the operational flow of one embodiment of the invention for inserting space in a geometric document.

FIG. 2 illustrates a computing environment for a client computer or server computer on which the various embodiments of the invention may run.

FIG. 3 shows one embodiment of the insert space module 116 of FIG. 1A.

FIG. 4 shows one embodiment of the group elements operation 204 of FIG. 3.

FIG. 5 shows an embodiment of the analyze shape group operation 211 of FIG. 3.

FIG. 6 illustrates an example of a geometric document where a split line passes through a shape element.

FIG. 7 illustrates an example of a geometric document where a split line passes through connecting lines between shapes.

### DETAILED DESCRIPTION OF PREFERRED EMBODIMENTS

The logical operations of the various embodiments of the present invention are implemented (1) as a sequence of computer implemented steps, or acts, or as program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, steps, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

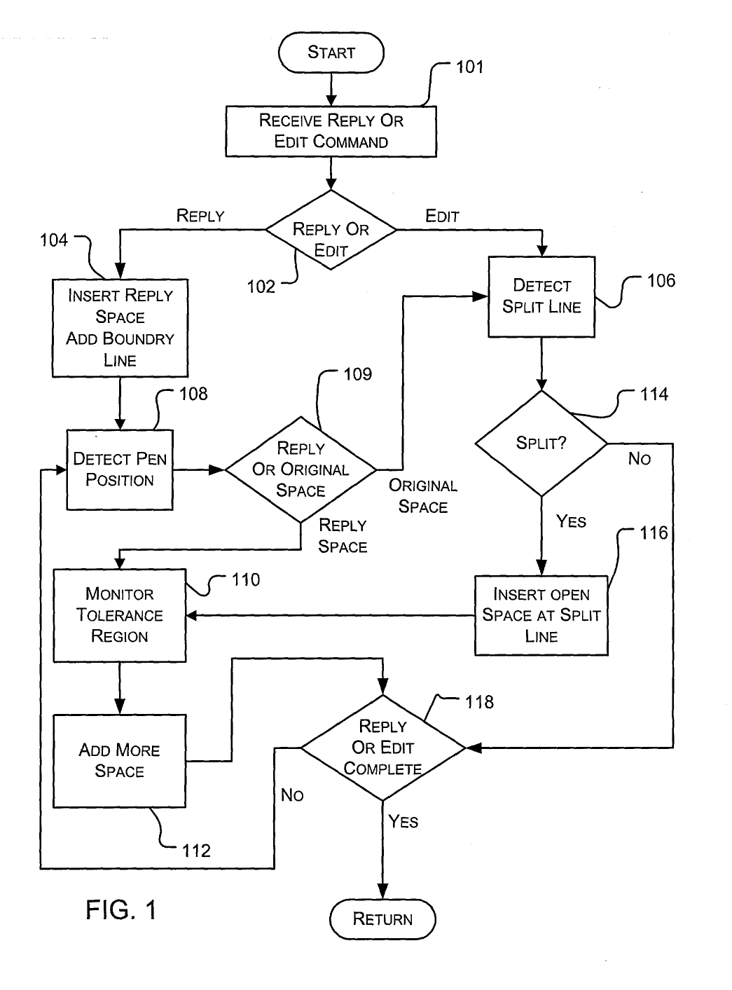

FIG. 1 is an illustration of the operational flow of one embodiment of the invention for inserting space in a geometric document. As described above, a geometric document is a document defined by geometrical space as opposed to a quantity of text lines or drawing fields and contains geometric elements—shapes, lines, text and pictures. When the geometric document is to be operated on within the context of a handwritten email, the user will select a function such as reply to the e-mail or edit the e-mail. When the user is replying to an e-mail, new space would typically be inserted at the top of the geometric document for the reply. Of course, the new space for a reply could be at the bottom of the geometric document or anywhere else in the document. Present convention is to insert the reply space at the top of the received e-mail document.

The user would signal his/her intent to work on the original document by selecting a reply or edit command on the computer display with a pointing device such as a pen or stylus. Of course other commands such as open, write, select, etc. could be used to initiate work on an original document, but typically a user would be preparing to reply to or edit the original document. Accordingly, those are the commands used in a preferred embodiment. Receive command operation 101 will monitor the selected commands looking for the reply or edit command. When one of these commands is received, detect operation 102 detects whether a reply or edit operation has been selected.

If a reply command is detected, then the operation flow branches to insert reply space module 104 to insert new space for the reply message and add a boundary line at a predetermined position in the geometric document. Typically for a reply, the new free, or open, space for the user to write a reply would be inserted at the top of the geometric document. The display of the existing document is shifted down a sufficient space to allow the user a few lines for writing, and a boundary line is added as a dashed line to indicate the demarcation between the original message and the reply message.

If an edit command is detected, the operation flow branches to split line detect operation 106. Split line detect operation scans the document to look for a boundary line or split line drawn across the document from one border to another border. This split line is drawn by the user moving the pen, stylus, or mouse to draw an electronic ink line across the displayed geometric document. A split line might be defined simply by fact that it is drawn from one margin or border to another. Alternatively, a split line might be defined by the user selecting a split line mode with the pen and then moving the pen to draw a split line across the document.

In a first instance, it is assumed an edit command is detected. After split line detect operation 106, the operation flow passes to split test operation 114. Split test operation 114 queries whether a split line was detected. If it was, the operation flow branches YES to insert open space module 116. The open space may be inserted automatically by inserting a predefined amount of space at the split line. Alternatively, the user may drag the split with the pointing device to create the open space interactively with the computing system. After the free, or open, space has been inserted, a second boundary, or split, line is added on the boundary of the new space across the open space from the first or original split line so that the user knows the boundaries of the new open space. The operation flow than proceeds to the monitor tolerance operation 110.

If split line detect operation 106 does not detect a split line, the operation flow branches NO from split query test operation 107. This might occur where the user wishes to annotate the original message in the original document space rather than to enter a message in new space opened in the original document. In this event, the operation flow branches NO to reply or edit complete test operation 118. The entry of electronic ink elements and the rendering of same on the display is performed in parallel in another program thread. One implementation of the operations for entry and rendering of the electronic ink is described in copending commonly assigned U.S. patent application Ser. No. (Atty. Docket No. 40002.8-US-U2), entitled “Providing Hand-Written and Hand-Drawn Electronic Mail Service” and filed concurrently herewith, which is incorporated herein by reference.

Reply or edit complete test operation 118 detects completion of the reply or edit by detecting a send command or a save command selected by the user. Of course completion might be detected numerous other ways such as by a time out interval since last entry, selection of a complete command, selection of another command besides reply or edit. If the reply or edit is complete, the operation flow branches YES to return to the main program flow. If the reply or edit is not complete the operation flow branches NO to pen position detect operation 108.

Pen position detect operation 108 is also reached if reply or edit command detect operation 102 detects a reply command. The operation flow then passes to insert reply space module 104. As described above, the reply space is inserted and a boundary line or split line is added by the system to indicate the edge location between the reply space (open space) and the original space in the document.

After insert reply space module 104 has inserted the open space and provided a boundary line, the operation flow passes to pen position detect operation 108. Operation 108 is detecting whether the pen is located inside the reply space or inside the original space. In effect the pen position detect operation 108 is detecting whether the input writing or drawing by the user is being performed inside the new open space for the reply or is in the region of the original space containing the original message. In the latter event, the user may want to insert open space in the original space and is drawing a split line. Alternatively the user may simply want to use electronic ink to add geometric elements in the original space without adding open space. Reply space or original space test operation 109 tests the detected position of the pen. If the pen position is in the original space, then the operation flow branches to the split line detect operation 106 described above.

If the user is writing or drawing inside the reply space, then the operation flow branches from test operation 109 to the monitor tolerance operation 110. The monitor operation is also reached from the insert open space operation 116 as described above. Whether the user is entering geometric elements, i.e. shapes, lines, text and pictures, in a reply space or in an open space created at a split line, monitor operation 110 is monitoring the position of the elements being inserted in the new space. As the elements approach the boundary line, the monitor operation detects an approach or an encroachment of the boundary line by the pen. This can be done a number of ways as for example sensing electronic ink entries within a distance of the boundary line equal to the normal height of one or more lines of text. Alternatively, the crossing of the boundary line by the pen could be sensed. Once the condition is sensed, an expansion condition is indicated and operation flow passes to add more space operation 112.

Add more space operation 112 when it receives the expansion condition adds additional open space, moves the original space to make room for the additional open space and moves the boundary line, or lines (as in the case of adding more space in open space which splits the original space), so that boundary line(s) stays at the edge of the original space. The amount of open space added to the new space can be preset. It can be also be reprogrammed by the user to selectable or default values. Alternatively, an opportunity could be provided for the user to drag the boundary to create more new space. After more space has been added to the new space, the operation flow passes to reply or edit complete test operation 118. As described above, test operation 118 will cause the operation flow to exit the reply and edit operation flow, if those tasks are complete, or will cause the operation flow to return to pen detect position 108 if those tasks are not complete.

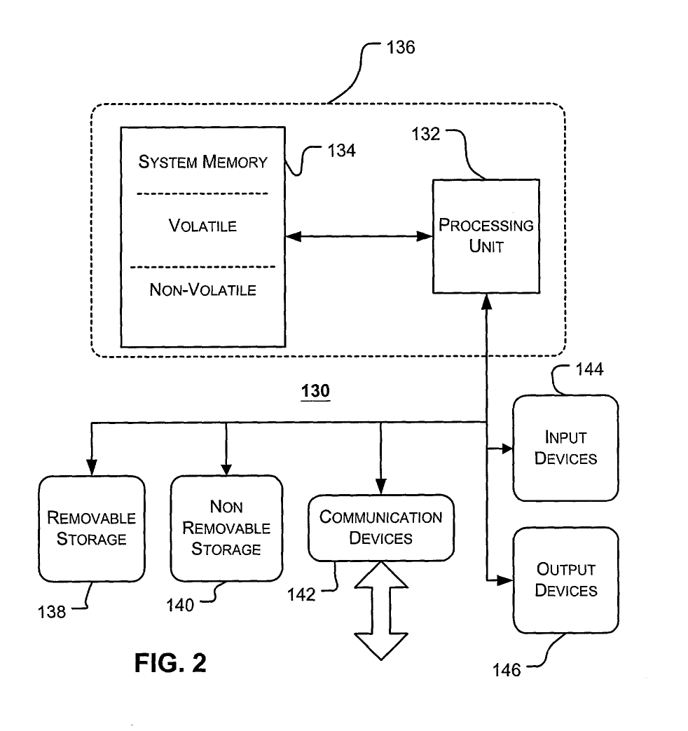

With reference to FIG. 2, an exemplary system for implementing the invention includes a computing system, such as computing system 130. Normally the implementation of the invention would include a server/client computing system and would likely be implemented in one or more client computing systems. One example is that shown and described in patent application Ser. No. (Atty. Docket No. 40002.8-US-U2), entitled “Providing Hand-Written and Hand-Drawn Electronic Mail Service” referred to above. Of course the invention could also be implemented in a stand alone computing system if the invention were applied to the entry or editing of elements in geometric documents on a stand alone computing system.

In its most basic configuration, computing system 130 typically includes at least one processing unit 132 and memory 134. Depending on the exact configuration and type of computing system, memory 134 may be volatile (such as RAM), non-volatile (such as ROM, flash memory, etc.) or some combination of the two. This most basic configuration is illustrated in FIG. 2 by dashed line 136. Additionally, system 130 may also include additional storage (removable and/or non-removable) including, but not limited to, magnetic or optical disks or tape. Such additional storage is illustrated in FIG. 2 by removable storage 138 and non-removable storage 140. Computer storage media includes volatile and nonvolatile, removable and non-removable media implemented in any method or technology for storage of information such as computer readable instructions, data structures, program modules or other data. Memory 134, removable storage 138 and non-removable storage 140 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by system 130. Any such computer storage media may be part of system 130.

System 130 may also contain communications devices 142 that allow the system to communicate with other systems. Communications devices 142 send and receive communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. The term computer readable media as used herein includes both storage media and communication media.

System 130 may also have input device(s) 144 such as keyboard, mouse, pen, stylus, voice input device, touch input device, etc. Output device(s) 146 include display, speakers, printer, etc. All these devices are well known in the art and need not be discussed at length here.

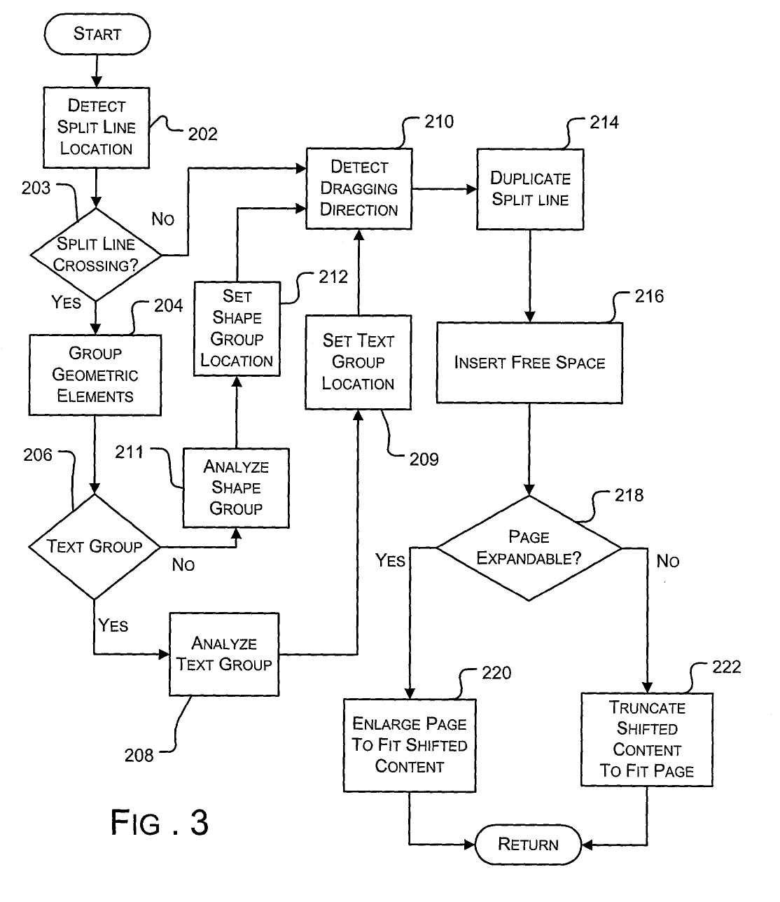

Referring now to FIG. 3, the insert space module 116 of FIG. 1 will be described in more detail. The operational flow of the insert space operations begins by detecting the location of the split, or boundary, line. Because the split line may not be a straight line, the split line location herein includes not only end points but path, i.e. location points along the split line. In one embodiment, the split line will be displayed on the user's tablet screen or computer display screen as a dashed line. After the location detect operation 202 detects the location of the split line, the operation flow proceeds to the split line crossing test operation 203.

Split line crossing test operation 203 is looking for geometric elements that are crossed by the split line. Strokes of handwritten characters might cross through the split line for example, where the character has a tail above or below the body portion of the character. Of course, a split line might be purposefully drawn through strokes of a character by the user. The split line might cross through pictures or shapes so that a portion of a picture or shape is on one side of the split line, and the remaining portion is on the other side of the split line. Connecting lines between shapes and annotation lines or dimension lines for a shape might be crossed by the split line. Crossing test operation 203 is testing or checking for any of the above crossings.

Alternatively, crossing test operation can be viewed as detecting when the split line passes cleanly across the document without touching any geometric element on the geometric document. If there are no crossings (which is normally the user's intent), then the operation flow branches NO from test operation 203 to detect dragging operation 210. In effect, the split line is clean, i.e. no crossings, and may be dragged so as to insert open space in the document. If there are one or more crossings of geometric elements by the split line, then the operation flow branches YES to group geometric elements operation 204.

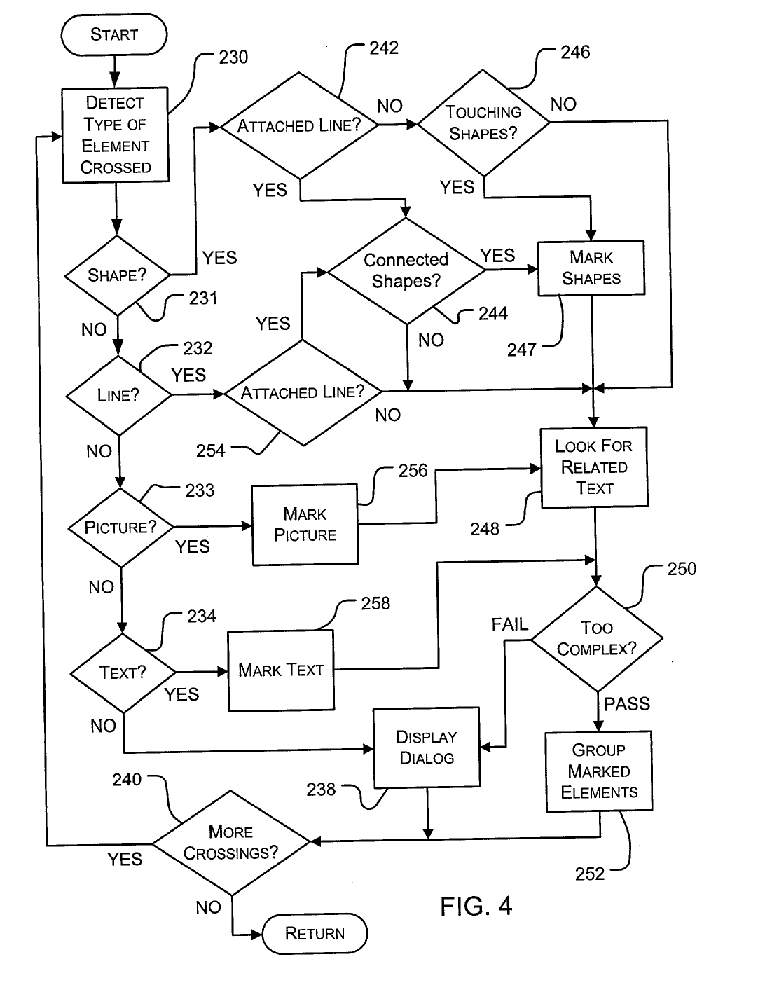

Group geometric elements operation 204 analyzes the relationships between geometric elements where at least one of the elements is crossed by the split line. Group operation 204 is analyzing the association between elements for the purpose of grouping related elements that would be split by the insertion of open space. Since the split line is drawn by the user, it will have the benefit of the user's judgment of where the split line should be relative to the geometric elements. The grouped elements provided by operation 204 are identified herein as a text group or a shape group. A text group includes only text. A shape group may be any one of the other types of geometric elements, i.e. one or a mix of any of the types of geometric elements —shape, pictures lines and text but no text alone. In other words a shape group is everything else except text alone. Some examples of shape groups would be a shape and its label, a picture and text identifying the picture, and two or more shapes connected by connecting lines. After the geometric elements related to an element crossed by the split line have been grouped, the group of element(s) are ready to be analyzed to select whether to locate the text group or shape group to one side or the other of the split line. The group geometric elements operation 204 is described in more detail hereinafter with reference to FIG. 4.

When the group elements operation 204 has been completed, text group test operation 206 detects whether the group created by operation 204 is a text group. If it is a text group, the operation flow branches YES to the analyze text group operation 208. The analyze text group operation 208 analyzes the spatial characteristics of the text group to decide where to locate the text group relative to the split line. Since crossings were detected by split line crossing detect operation 203, the text group must contain character strokes that are crossed by the split line. Text in the form of electronic ink is grouped by group operation 204 as words, phrases, sentences or even paragraphs. Analyze operation 208 defines the spatial area of the text group and analyzes that area for its center of mass treating the area as if it has a uniform of distribution mass. Based on the location of the center of mass of the text group on one side or the other of the split line, the entire electronic ink text group is can be re-located to the same side of the split line as the center of mass location. Set location operation 209, receives the text group analysis information such as center of mass location and sets the location of the text group on the same side of the split line as the center of mass. Setting the location of the text group may involve moving the split line unless there is space available where the text group may be moved to or relocated.

While one preferred embodiment for analysis of the text group uses a center of mass analysis, other spatial analysis techniques might be used. These analysis techniques might include characteristics such as character counts, word counts or the number of text lines on each side of the split line. The text group analysis information would indicate which side of the split line has the highest count. Another technique might look at the circumference of the text group area and indicate which side of the split line has the highest portion of the circumference. It will be apparent to one skilled in the art that any number of analysis techniques might be chosen. The goal is to determine the most appropriate location for the text group relative to the split line.

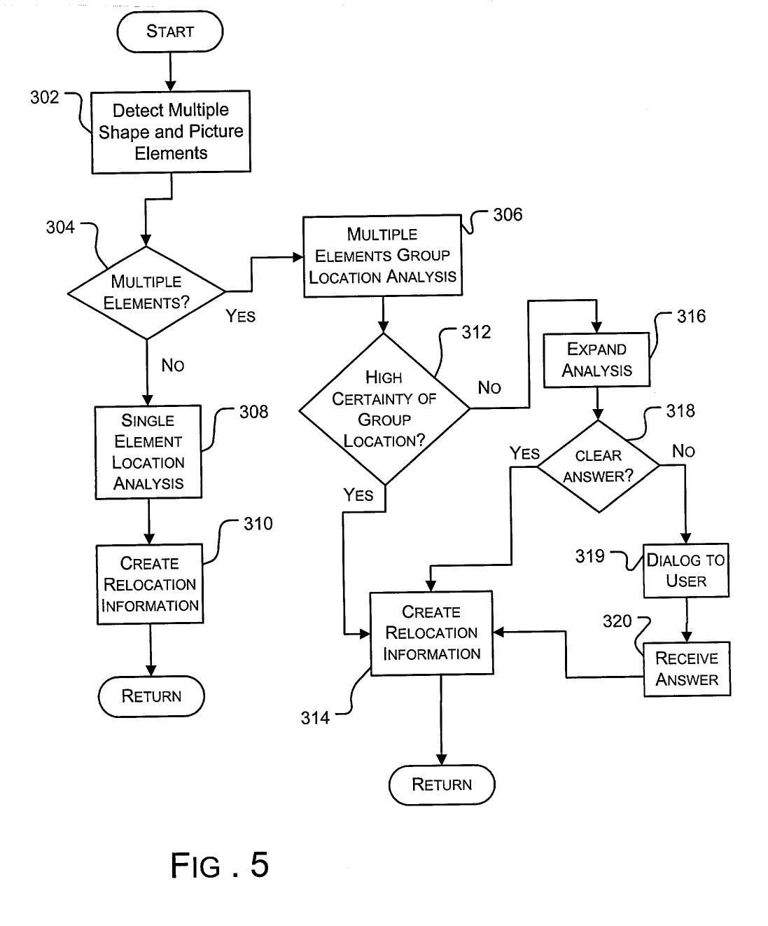

If the text group test operation 206 detects the group is not a text group, the operation flow branches NO to analyze shape group operation 211. As explained earlier a shape group may include all types of geometric elements. The location of shapes, pictures and associated text and lines in the shape group on one side or the other of the split line is set according to the shape group analysis operation 211. In one preferred embodiment, the analysis is performed by assigning a spatial area to the shapes group and then computing the location of the center of mass of the shape group. Just as described above for the text group analysis, the shape group will have its location set based on the location of its center of mass being on one side or the other of the split line. A more complex spatial analysis may be performed for finding the proper location of the shape group. One example of such an analysis will be described hereinafter with reference to that FIG. 5.

After shape group location is determined by analysis operation 211, the operational flow passes to set shape group location operation 212. Set location operation 212 will receive shape group location analysis information and move the shape group to that side of the split line if space is available. Alternatively, the set location operation will redraw the split line around the shape group. After the shape group location is set and the shape group is moved, or the split line is redrawn around the shape group, then operation flow proceeds to drag detect operation 210 to detect the direction of dragging of the split line.

Drag direction detect operation 210 monitors the pen or stylus input of the user to detect the direction in which the user drags the split line. As the user begins to drag the split line, duplicate line operation 214 immediately creates and displays a duplicate split, or boundary, line adjacent the original split line. The duplicate split line matches the course of the original split line across the document and accordingly is parallel to the original split line.

As the user drags the duplicate split line with the pen in a direction to insert space, the original split line stays at the original split line position. As the duplicate line is dragged away from the original line, free space opens in the document. This rendering of a duplicate split line and the insertion of free space or open space is performed by insert operation 216 when the user drags the duplicate split line away from the original split line. When the user determines that enough space has been provided by dragging the duplicate split line, the drag operation is stopped by the user and the document now includes two boundary lines with an initial boundary line at the original split line position and a new boundary line at the duplicate split line position. The open space, or free space, is between these two boundary lines or split lines. In this free space the user may then use electronic ink techniques to handwrite additional text or free hand draw shapes and lines or paste pictures in the document.

In another embodiment of the invention, the user does not drag the split line but rather moves the cursor to a new position for the duplicate split line and clicks on that new split line position to insert space. Alternatively, the user might scroll to a new position and click to actuate the new split line position. Also, a user might have predefined amounts of new space as screen buttons that may be selected with the pointing device. Further, a user might select scale markers on the page window to indicate original split line position and new split line position. It will be apparent to one skilled in the art that any number of techniques might be used to define the amount of new space to be inserted at the split line.

Upon insertion of the open space in the document, expansion test operation 218 tests whether the page of the document can be expanded to accommodate the original message and the added open space. The electronic pages or the complete document might have a limitation to their size. Expansion test operation 218 is detecting if there is enough space in the predefined size for the document page such that when the free space is added, the original message and new open space still fit on the document or its page. If the answer to the expansion test is YES, then the operation flow branches to enlarge operation 220, which enlarges the document or the electronic page to fit the shifted original message content plus the open or free space. On the other hand, if the page is not expandable, then the operation flow branches NO to truncate operation 222. The truncate operation reduces the size of the shifted content, the original message, so that the original message still fits on the page after the free space has been inserted. Upon insertion of the free space, the program flow returns to the program flow in FIG. 1 at monitor operation 110.

FIG. 4 shows the operational flow for the group geometric elements operation 204. The operation flow begins at detect element type operation 230. Operation 230 detects the type of element that is crossed by the split line. The element type will be shape, line, picture or text. Depending upon the type of element detected, the operation flow will branch YES from shape test operation 231, line test operation 232, picture test operation 233 or text test operation 234. If none of these element types are detected, then the operation flow will branch NO through all of the operations 231, 232, 233 and 234 to display dialog operation 238. Operation 238 displays a dialog box to the user indicating that a geometric element has been crossed, and the system cannot determine how to group the elements for relocation. A dialog box may give the user the opportunity to redraw the split line or may simply offer to split the document where the current line is without regrouping and moving elements. After the user responds, the operation flow proceeds to “more crossings” test operation 240 to detect whether additional crossings by the split line were detected by split line crossing test operation 203 in FIG. 3. If there are additional crossings then the operation flow returns to detect element type operation 230 to detect the type of element crossed.

Now assuming the type of element crossed is a shape, the operation flow will branch YES from shape test operation 231 to attached line test operation 242. Attached line test operation is detecting the presence of one or more lines attached to the shape crossed by the split line. If the shape has an attached line, the attached line could be either an annotation line or a connecting line. When there is an attached line, the operation flow branches YES from attached line test operation 242 to connected shapes detect operation 244. Operation 244 detects additional shape or shapes connected to the crossed shape, i.e. the shape crossed by the split line, by the attached line or lines. Such shapes if present are marked by mark shapes operation 247 for inclusion in the set of elements being collected as a group. After mark shapes operation 247, “look-for-related-text” operation 248 identifies text related to the marked shapes. The text might be related to the shapes because text refers to the shapes or because the text is located adjacent the shapes.

Examples of related text for the marked shapes might be a label or a brief descriptive reference to the marked shapes. The look-for-related-text operation 248 might be identifying related text based on reference numerals annotating the shapes and used in the text. Any criteria might be used to determine the relationship between the text and shapes and could be programmed into the look-for-related-text operation. It will be apparent to one skilled in the art that any number of tests might be developed to test for this related text.

If connected shapes operation 244 does not detect connected shapes attached to the attached line of the crossed shape, then the attached line would be an annotation line. The operation flow branches NO from operation 244 to look-for-related-text operation 248. Operation 248 in this instance will be looking for the annotation text. The annotation text will likely be found because of its proximity to one end of the annotation line.

If the crossed shape does not have an attached line, the operation flow branches NO from attached line test operation 242 to touching shapes test operation 246. If there are a plurality of shapes that are touching, test operation 246 will detect this and branch the operation flow YES to mark shapes operation 247. The shapes that are connected to the crossed shape, in this case by touching the crossed shape, are marked as a set of elements that should be grouped together. If there are no touching shapes, the operation flow branches NO to look-for-related-text operation 248. In this event, the crossed shape must be a single shape, and related text might be a label or descriptive text associated with the single shape.

From the look-for-related-text operation 248, the operation flow proceeds to complexity test operation 250. Complexity test operation 250 detects whether or not the elements marked as a grouped clearly form a group or there are multiple alternatives for the grouping different geometric elements into a set. The complexity test operation might accumulate confidence scores when marking shapes as included in the group. If the accumulated confidence score is below a threshold value, the complexity test would fail. If there are too many alternatives, the complexity test could detect the number of alternatives and based on that fail the test. If the test is failed, the operation flow will branch along the FAIL path to display dialog operation 238. As described above, operation 238 will display a dialog box to the user to give the user an opportunity to accept of reject a grouping of elements.

If the element grouping passes the complexity test in test operation 250, the operation flow proceeds to group marked elements operation 252. Operation 252 identifies the marked elements as a group and defines the group as a shape group or a text group as previously defined in the description of FIG. 3. After the elements have been identified in the group, then the operation flow proceeds to “more crossings” test operation 240 to detect whether there are additional geometric elements crossed by the split line that have not yet been analyzed for grouping. If there are none, then the operation flow branches NO to return to the main program flow, i.e., text group test operation 206 in FIG. 3.

If the detected element type in detect operation 230 is a line element, then line element test operation 232 would be satisfied, and the operation flow would branch YES to attached line test operation 254. Test operation 254 detects if the crossed line, i.e. the line element crossed by the split line, is attached to a shape. If it is attached to a shape, the operation flow branches YES from test operation 254 to connected shapes detect operation 244. Operation 244 discussed above detects there is more than one shape connected to the attached line i.e. a shape in addition to the shape detected by the attached line test operation 254. If there are additional connected shape(s) detected, the operation flow proceeds as described above for operations 244, 247 and 248 (the connected shapes sequence of events). If there is no additional shape detected in operation 244, the operation flow proceeds to operation 248 as described above (the annotation sequence of events).

If the line crossed by the split line is not an attached line then the operation flow branches from attached line test operation 254 to look-for-related-text operation 248. Look-for-related-text operation 248 will find the text associated with the unattached line and operates in a manner similarly to that discussed above for look-for-related-text operation 248. An unattached line may be a dividing line or a demarcation line.

If the geometric element crossed by the split line is a picture type or a text type, then the operation flow will branch YES respectively from picture test operation 233 and text test operation branch 234. If a picture element is detected, mark picture operation 256 marks the picture for inclusion in a group, and look-for-related text operation 248 looks for text related to the picture. The related text might be a label or descriptive text associated with the picture and would be marked to be grouped with the picture. The options for identifying the related text are many as described above. If a text element is detected, mark text operation 258 blocks and marks the inter-related text as a text element for treatment as a group.

After all of the elements crossed by a split line have been processed as a group as detected by the more crossings test operation 240, the operation flow will pass through more crossings test operation 240 and return to the text group test operation 206 in FIG. 3.

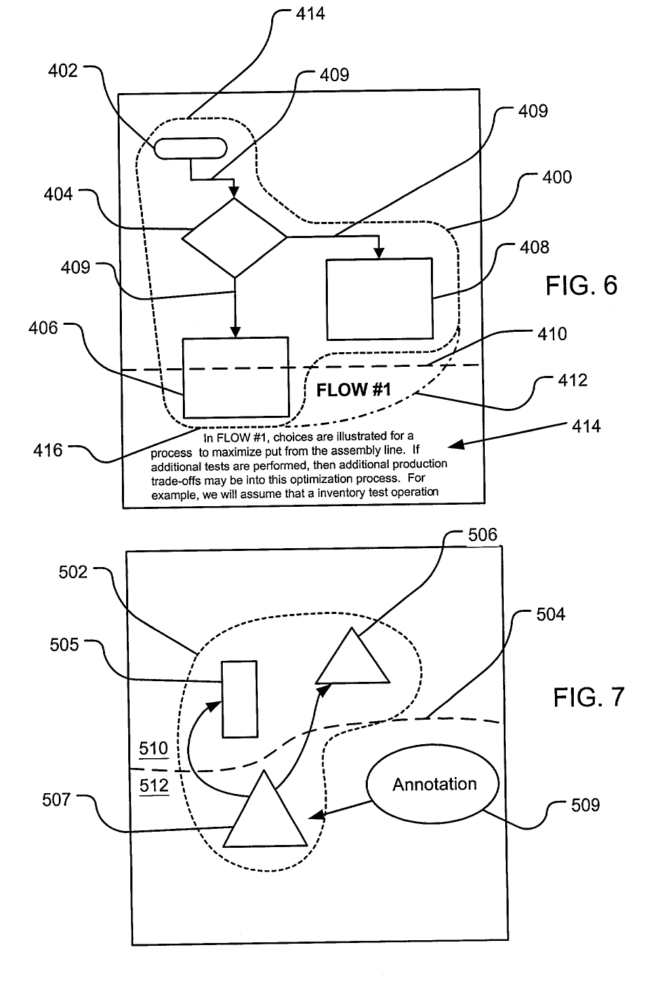

FIG. 5 shows the operational flow for the analyze shape group operation 211 in FIG. 3. In FIG. 5 the analysis to relocate a shape group on one side or the other of a split line begins at detect multiple elements operation 302. Since this is a shape group, it is known that the group will not have text element(s) only. On the other hand it is much simpler to analyze a single shape or picture element with possible related text than it is to analyze a shape group containing multiple shapes and or picture elements with possible related text. Multiple elements test operation 304 tests whether detect operation 302 detected multiple shape and/or picture geometric elements or a single shape or picture geometric element. If there are multiple elements in the shape group as in both FIGS. 6 and 7, the multiple elements test operation 304 branches the operation flow YES to the multiple elements location analysis operation 306. If there is a single shape or picture element in the shape group, the operation flow branches NO to single element location analysis operation 308.

Single element location analysis operation 308 will be able to discern whether a single shape or picture should be relocated on one side of the split line or the other. For example if the split line goes through a portion of a single shape or picture in a shape group having only a single shape or picture element, then analysis operation 308 might calculate the center of mass of the single shape or picture. For simplicity of explanation, this example assumes there is no annotation line and/or no related text grouped with the single shape or picture element. If there are such line elements and/or text elements in the shape group having a single shape or picture element, these line and text elements would be included in the location analysis performed by single shape or picture analysis operation 308. The center of mass calculation is based on a uniform distribution of mass throughout the area of the shape or picture element. Operation 308 would indicate that the center of mass of the element is on one side or the other of the split line.

After this location analysis operation 308, create operation 310 marks the single element shape group for relocation and generates relocation information. The relocation information will indicate a location on the side of the split line where the center of mass is located for the shape group. Of course, other analysis techniques might be used as described below for group location analysis 306. From create operation 310 the operation flow then returns to set shape group location operation 212 in FIG. 3.

If there are multiple shape or picture elements in the shape group, the operation flow branches from multiple elements test operation 304 to multiple elements group location analysis operation 306. Operation 306 evaluates the group as a whole for placement on one side or the other of the split line. Again, the evaluation might be looking for the center of mass of the shape group area to select a relocation side for the shape group. In FIG. 6 a shape group 400 has been defined by group geometric elements operation detailed in FIG. 4 as including the shapes 402, 404, 406 and 408 connected by connecting lines 409 between the shapes. Shape 406 is the crossed shape, i.e. the shape crossed by split line 410. The center of mass of shape group 400 is clearly above the split line 410. Even if the label “FLOW #1” is added to shape group 400 as related text so that the area of the shape group now extends to contour 412, the shape group center of mass is still clearly above the split line 410. Therefore, shape group 400 including the related text “FLOW #1” would be placed above split line 410 when open space is inserted. The space would be inserted between shape group 400 and text 414.

Alternatively, the evaluation by group location analysis operation 306 might look for other spatial characteristics. Operation 306 could count the number of shapes on each side of the split line and select the side having the most shapes. In the example of FIG. 7, the shape group 502 includes shapes 505, 506 and 507. Split line 504 crosses connecting lines 508 in the shape group. In this example the position of the center of mass of the shape group 502 is not as certain as in FIG. 6. However if the location analysis operation 306 counts the number of shapes on each side of the split line, there are more shapes 505 and 506 above the split line 504 than below the split line.

FIG. 7 also shows an unconnected annotation 509. Annotation 509 has an arrow 510 pointing to but not connected to shape 507. This annotation would likely be formed into shape group 502 as related text. If the area of the text element in the annotation 509 is included in shape group 502, a center of mass test for relocating the shape group becomes very uncertain. A counting of shapes analysis would still lead to relocating the shape group 502 above the split line 504.

Other spatial characteristics, that might be used for selecting which side of the split line to place the shape group, would be direction of connection lines when they have direction, the amount of available space for relocation, the contour (an imaginary line surrounding a shape group) of the shape group such as maximum distance of contour above and below split line, the relocation of shapes in the shape group so that the shape group assumes a new contour, the circumference of the contour of the shape group and the area within the contour above and below the split line, etc. These various criteria and others might be used singly or in combination by the analysis operations 306, 308 to select the side of the split line on which to locate the shape group.

After the group location analysis is complete, high certainty test operation 312 is looking for indicators of a strong certainty that the shape group should be located on the side of the split line determined by analysis operation 306. For example in shape group 502 in FIG. 7, there are multiple connection lines between one shape 507 on one on one side 510 of the split line 504 and two shapes 505 and 506 on the other side 512 of the split line. This would add to the certainty that all three shapes should be placed on side 510 of the split line. Another indicator of high certainty might be that the center of mass of shape group 501 is more than a predetermined distance from the split line. This predetermined distance could be expressed as a number of picture elements or a percentage of the page for example. Another indicator of high certainty might be the difference between the maximum distances the shape group contour extends on each side from the split line. If this difference were greater than some threshold value such as some percentage of the height of the page, than there would be a high certainty in group location. For example in FIG. 6, the top 414 of shape group 404 is much farther from split line 410 than the bottom 416 of the shape group. Other criteria related to geometry of the page and geometry of elements in the shape group might be used to determine high certainty.

If such a high certainty is detected, then the operation flow branches YES from high certainty test operation 312 to create relocation information operation 314. Create operation 314 marks the multiple element shape group for relocation to the side of the split line as determined by group location analysis 306 and generates the group relocation information for the shape group. However, if there is no high certainty on the location of the shape group, then the operation flow branches NO from the certainty test 312 to the expanded analysis operation 316.

For example in FIG. 7, if the annotation 509 had been picked up as a text element in the shape group, than the shape group 502 with the area of annotation 509 added to it would be much more evenly distributed about split line 504. In this situation the high certainty test operation might cause the operation flow to branch NO to expanded analysis operation 316.

The expanded analysis operation 316 will use a number of more elaborate group location analysis operations to determine on which side of the split line to place the shape group. In one embodiment, an individual shape center of analysis is used. Each of the geometric elements in the shape group is analyzed for its center of mass. The center of mass for the shape group is than computed as a combined center of mass based on the center of mass of each geometric element and its distance from the split line. The location of the center of mass would then be an indicator to locate the shapes together on one side or the other of the split line. In another expanded analysis, the center of mass of all the geometric elements on each side of the split line would be determined. Accordingly there would be a center of mass above and below the split line. The location of the shape group would be based on which center of mass was further from the split line; i.e. the shape group would be moved to that side of the split line. Of course other more elaborate analyses might be performed based on the geometry of the shape group itself or the geometry of elements in the shape group.

After the expanded analysis is completed, clear answer test 318 will detect whether the answer indicated by the expanded analysis is clear. This test is similar to the high certainty test though it might have a lower threshold of certainty. The test for a clear answer might be comparing a test value to a threshold value. The test value might be based on the distance of the center mass from the split line as described above for the high certainty test operation. The test value might also be based on the difference in distance from the split line for the two center of masses if the double center of mass analysis described above is used. If there is no clear answer, then the operation flow will branch NO from test operation 318 to dialog display operation 319.

Dialog operation 319 will create a dialog box and display it to the user. The user may then input an answer such as by touching the pen above or below the split line or select above or below answers provided in the dialog box. This answer is received by operation 320, and the create operation 314 marks the shape group for relocation to the side of the split line indicated by the user's answer in the dialog box. The operation flow then returns to set shape group location operation 212 in FIG. 2.

While the invention has been particularly shown and described with reference to preferred embodiments thereof, it will be understood by those skilled in the art that various other changes in the form and details may be made therein without departing form the spirit and scope of the invention.

We claim:

1. A method for adding open space in a geometric document having original space containing an original message with original geometric elements, the method comprising:
detecting a command indicating a user wishes to add space to the geometric document;
adding one or more boundary lines to separate the original space and the open space;
inserting open space adjacent a boundary line in the geometric document;
detecting proximity of new geometric elements entered in the open space to the boundary line and indicating when the new geometric elements are within a tolerance region of the boundary line;
adding more open space when the new geometric elements are within the tolerance region.

2. The method of claim 1 wherein the boundary line is a split line located among geometric elements in the document and said act of inserting comprises:
detecting original geometric elements crossed by the split line;
grouping any original geometric elements connected to or related to the geometric element crossed by the split line to form a group of geometric elements;
analyzing the group of geometric elements to determine if the group should be relocated on a first side or a second side of the split line;
dragging the split line from an original position to a new position while leaving a duplicate split line at the original split line position;
and inserting open space between the original position of the split line and the new position of the split line.

3. The method of claim 2 wherein there are a plurality of types of geometric elements and the act of grouping comprises:
detecting the geometric element crossed by the split line as the crossed geometric element;
marking geometric elements connected or related to the crossed geometric element to create marked geometric elements; and
grouping marked geometric elements so as to form the group of geometric elements.

4. The method of claim 3 and in addition:
testing the complexity of the marked geometric elements as a group and indicating whether or not the group is too complex;
passing the marked geometric elements to the act of grouping marked geometric elements if the group is not too complex; and
displaying a dialog to user to invite the user to accept or reject a group if the group is too complex.

5. The method of claim 3 wherein the act of analyzing comprises:
detecting spatial characteristics of the group of geometric elements; and
evaluating the spatial characteristics against predetermined criteria to determine a group location for the group of elements on the first or second side of the split line.

6. The method of claim 5 and in addition:
testing whether or not the group location has a predetermined certainty;
expanding analysis of the spatial characteristics;
dialoging with the user if the act of expanding the analysis does not provide a clear answer for the group location; and
creating relocation information indicating the group location is on the first or second side of the split line if the act of expanding the analysis does provide a clear answer.

7. In an electronic-mail computing system having a display and a pointing device for entering geometric elements in a geometric document, a method for inserting additional writing space in an existing geometric document having original space with one or more original geometric elements, the method comprising:
detecting a split line entered on the geometric document;
detecting original geometric elements crossed by the split line and identifying them as crossed geometric elements;
grouping any original geometric elements connected to or related to the crossed geometric elements to collect one or more geometric element groups;
analyzing each of the geometric element groups to determine which side of the split line each group should be located;
dragging a duplicate split line from an original position split line position to a new position while leaving the split line at the original split line position;
and inserting open space between the split line and the duplicate split line.

8. The method of claim 7 wherein there are a plurality of types of geometric elements and the act of grouping comprises:
marking geometric elements connected or related to the crossed geometric elements to create marked geometric elements; and
grouping the marked geometric elements into one or more groups of geometric elements.

9. The method of claim 8 wherein the act of analyzing comprises:
detecting spatial characteristics of each group of geometric elements; and
evaluating the spatial characteristics against predetermined criteria to determine a group location for each group of elements on one side or other side of the split line.

10. The method of claim 9 and in addition:
testing whether or not each group location has a predetermined certainty;
expanding analysis of the spatial characteristics for each group whose group location does not meet the predetermined certainty;
dialoging with the user if the act of expanding the analysis does not provide a clear answer for a group location; and
creating relocation information indicating a group location on one side of the split line if the act of expanding the analysis does provide a clear answer.

11. The method of claim 8 and in addition:
testing the complexity of the marked geometric elements as a group and indicating whether or not the group is too complex;
passing the marked geometric elements to the act of grouping marked geometric elements if the group is not too complex; and
displaying a dialog to user to invite the user to accept or reject a group if the group is too complex.

12. Apparatus for adding open space in an electronic geometric document displayed on a display screen, the geometric document having original space for the entry of geometric elements into the geometric document, the apparatus comprising:
means for detecting a command indicating a user wishes to add space to the geometric document;
means for adding one or more boundary lines to separate the original space and the open space; and
means for inserting open space adjacent a boundary line in the geometric document.

13. The apparatus of claim 12 further comprising:
means for detecting proximity to the boundary line of the geometric elements entered in the geometric document and indicating when the geometric elements are within a tolerance region of the boundary line;
means for adding more open space when the geometric elements are within the tolerance region.

14. The apparatus of claim 12 wherein the boundary line is a split line located among geometric elements in the geometric document and said means for inserting comprises:
means for detecting geometric elements crossed by the split line;
means for grouping any geometric elements connected to or related to a geometric element crossed by the split line to form a group of geometric elements;
means for analyzing the group of geometric elements to determine if the group should be relocated on a first side or a second side of the split line;
means for selecting a new split line position different from an original split line position; and
means for adding open space in the geometric document between the original split line position and the new split line position.

15. The apparatus of claim 14 wherein said means for grouping comprises:
means for detecting the geometric element crossed by the split line as the crossed geometric element;
means for marking geometric elements connected or related to the crossed geometric element to create marked geometric elements; and
means for grouping marked geometric elements so as to form the group of geometric elements.

16. The apparatus of claim 15 and in addition:
means for testing the complexity of the marked geometric elements as a group and indicating whether or not the group is too complex;
means for passing the marked geometric elements to said means for grouping marked geometric elements if the group is not too complex; and
means for sending a dialog message to the display screen to invite the user to accept or reject a group if the group is too complex.

17. The apparatus of claim 14 wherein said means for analyzing comprises:
means for detecting spatial characteristics of the group of geometric elements; and
means for evaluating the spatial characteristics against predetermined criteria to determine a group location for the group of elements on the first or second side of the split line.

18. The apparatus of claim 17 and in addition:
means for testing whether or not the group location has a predetermined certainty;
means for expanding analysis of the spatial characteristics;
means for dialoging with the user if said means for expanding the analysis does not provide a clear answer for the group location; and
means for creating relocation information indicating the group location is on the first or second side of the split line if said means for expanding the analysis does provide a clear answer.

19. A computer program product readable by a computing system having a display and a pointing device for entering geometric elements in a geometric document and encoding a computer program of instructions for executing a computer process for inserting additional writing space in an existing geometric document having original space with one or more original geometric elements, the method comprising:
detecting a split line entered on the geometric document;
detecting original geometric elements crossed by the split line and identifying them as crossed geometric elements;
grouping any original geometric elements connected to or related to the crossed geometric elements to collect one or more geometric element groups;
analyzing each of the geometric element groups to determine which side of the split line each group should be located;
dragging a duplicate split line from an original position split line position to a new position while leaving the split line at the original split line position;
and inserting open space between the split line and the duplicate split line.

20. The computer program product of claim 19 wherein there are a plurality of types of geometric elements and the act of grouping comprises:
marking geometric elements connected or related to the crossed geometric elements to create marked geometric elements; and
grouping the marked geometric elements into one or more groups of geometric elements.

21. The computer program product of claim 20 wherein the act of analyzing comprises:
detecting spatial characteristics of each group of geometric elements; and
evaluating the spatial characteristics against predetermined criteria to determine a group location for each group of elements on one side or other side of the split line.

22. The computer program product of claim 21 and in addition:
testing whether or not each group location has a predetermined certainty;
expanding analysis of the spatial characteristics for each group whose group location does not meet the predetermined certainty;
dialoging with the user if the act of expanding the analysis does not provide a clear answer for a group location; and
creating relocation information indicating a group location on one side of the split line if the act of expanding the analysis does provide a clear answer.

23. The computer program product of claim 19 and in addition:
testing the complexity of the marked geometric elements as a group and indicating whether or not the group is too complex;
passing the marked geometric elements to the act of grouping marked geometric elements if the group is not too complex; and
displaying a dialog to user to invite the user to accept or reject a group if the group is too complex.
